(19) United States
(12) Patent Application Publication
(10) Pub. No.: US 2026/0284792 A1
(43) Pub. Date: Sep. 24, 2026

(54) Electrode Manufacturing Equipment

(71) Applicant: SK ON CO., LTD, Seoul (KR)

(72) Inventors: Joon Ho BAE, Daejeon (KR); Song Hyeon KIM, Daejeon (KR)

(21) Appl. No.: 19/490,979

(22) PCT Filed: May 16, 2024
(86) PCT No.: PCT/KR2024/095775

§ 371 Date: Dec. 8, 2025

(30) Foreign Application Priority Data
Jun. 8, 2023 (KR) 10-2023-0073623

(51) Int. Cl. B23K 26/38; B23K 26/08; B23K 26/70; B23K 37/04; B23K 101/36; H01M 4/04

(52) U.S. Cl. CPC B23K 26/38; B23K 26/083; B23K 26/0876; B23K 26/704; B23K 37/0443; H01M 4/0471; B23K 2101/36

(57) ABSTRACT

Electrode manufacturing equipment is disclosed. The electrode manufacturing equipment of the present disclosure includes a transfer unit having a transfer roller configured to transport an electrode sheet forward; a cutting unit having a cutter configured to cut the electrode sheet; and a delivery unit positioned in front of the transfer unit, wherein the delivery unit includes: a track frame disposed in front of the transfer unit and having an upper track extending forward from a rear end; and a mover movably coupled to the track frame.

### CROSS-REFERENCE TO RELATED APPLICATIONS

This application is a National Stage Entry of International Patent Application No. PCT/KR2024/095775, filed May 16, 2024, which claims benefit and priority to Korean Patent Application No. KR 10-2023-0073623, filed Jun. 8, 2023, each of which is incorporated by reference in their entireties for all purposes.

### TECHNICAL FIELD

The present disclosure relates to electrode manufacturing equipment.

### BACKGROUND ART

A process of producing an electrode by cutting an electrode sheet using a mold while unwinding an electrode roll wound with the electrode sheet has limitations in terms of improving production speed. Accordingly, when the electrode sheet is cut without stopping transport of the electrode sheet, the production speed of the electrode manufacturing process may be relatively increased.

### SUMMARY OF INVENTION

### Problems to be Solved by Invention

An object of the present disclosure is to address the above-described problems and other problems.

Another object of the present disclosure is to provide electrode manufacturing equipment with an improved electrode production speed.

Yet another object of the present disclosure is to provide electrode manufacturing equipment that maintains transport of an electrode sheet.

### Means for Solving Problems

To achieve the above or other objects, according to an aspect of the present disclosure, there may be provided electrode manufacturing equipment including: a transfer unit having a transfer roller configured to transport an electrode sheet forward; a cutting unit having a cutter configured to cut the electrode sheet; and a delivery unit positioned in front of the transfer unit, wherein the delivery unit includes: a track frame disposed in front of the transfer unit and having an upper track extending forward from a rear end; and a mover movably coupled to the track frame.

### Advantageous Effects

According to at least one embodiment of the present disclosure, electrode manufacturing equipment with an improved electrode production speed may be provided.

According to at least one embodiment of the present disclosure, electrode manufacturing equipment that maintains the transport of an electrode sheet may be provided.

The electrode manufacturing equipment of the present disclosure may be widely applied in green technology fields, such as electric vehicles, battery charging stations, as well as solar power generation, wind power generation, and the like, which use the batteries.

The electrode manufacturing equipment of the present disclosure may be used in eco-friendly electric vehicles, hybrid vehicles, and the like, which are aimed at mitigating climate change by reducing air pollution and greenhouse gas emissions.

### BRIEF DESCRIPTION OF DRAWINGS

FIG. 1 is a perspective view illustrating electrode manufacturing equipment according to an embodiment of the present disclosure.

FIG. 2 is a plan view illustrating an electrode sheet and a cutting unit.

FIG. 3 is a side view illustrating a delivery unit according to an embodiment of the present disclosure.

FIG. 4 is a cross-sectional view of the delivery unit shown in FIG. 3 taken along line X1-X2.

FIG. 5 is a cross-sectional view illustrating a track frame of the delivery unit shown in FIG. 4.

FIG. 6 is a cross-sectional view illustrating a mover of the delivery unit shown in FIG. 4.

FIG. 7 is a cross-sectional view illustrating a mover, where an upper surface of the mover body forms an upper surface of the mover.

FIG. 8 is a view illustrating a PNP module according to an embodiment of the present disclosure.

FIG. 9 is a block diagram illustrating electrode manufacturing equipment according to an embodiment of the present disclosure.

### MODE FOR CARRYING OUT INVENTION

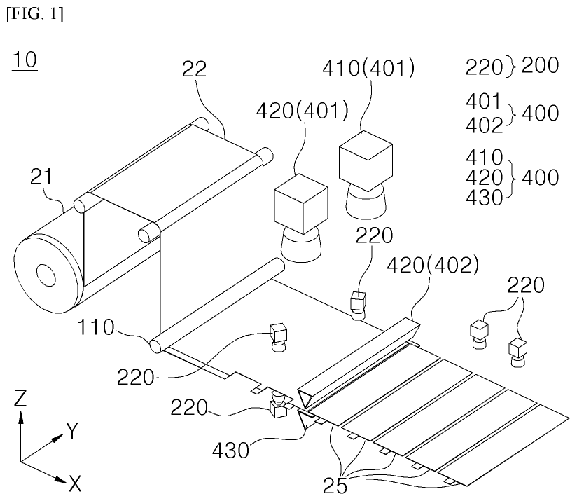

Hereinafter, the present disclosure will be described in detail with reference to FIGS. 1 to 9. However, these are merely illustrative, and the present disclosure is not limited to the specific embodiments described as examples.

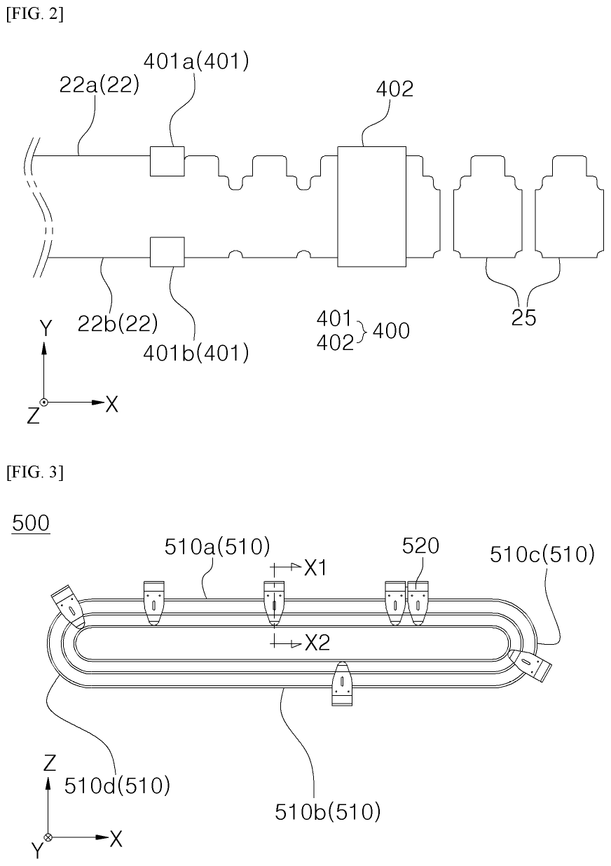

FIG. 1 is a perspective view illustrating electrode manufacturing equipment according to an embodiment of the present disclosure. FIG. 2 is a plan view illustrating an electrode sheet and a cutting unit.

Referring to FIGS. 1 and 2, electrode manufacturing equipment 10 may process an electrode sheet 22 to produce an electrode 25. For example, the electrode 25 may be used for a secondary battery or the like.

The electrode sheet 22 may be formed of a material including metal. For example, the electrode sheet 22 may be formed of a material including at least one of copper (Cu) and aluminum (Al). The electrode sheet 22 may have a sheet shape extending in one direction or is elongated.

The electrode sheet 22 may be unwound from a wound state. For example, an electrode roll 21 may be in a wound state with the electrode sheet 22. For example, the electrode sheet 22 may be transported forward by being unwound from the electrode roll 21. For example, the electrode sheet 22 may be transported while being unwound in an X-axis direction.

The electrode manufacturing equipment 10 may include a transfer unit 100. The transfer unit 100 may include a transfer roller 110. The transfer roller 110 may be rotatable to transport the electrode sheet.

The transfer roller 110 may contact the electrode sheet 22. The transfer roller 110 may support the electrode sheet 22. The transfer roller 110 may transmit rotational force to the electrode sheet 22. When the transfer roller 110 transmits rotational force to the electrode sheet 22, the electrode sheet 22 may linearly move in one direction. For example, the electrode sheet 22 may move forward.

The electrode manufacturing equipment 10 may include a cutting unit 400. The cutting unit 400 may include an edge cutting module 401. The edge cutting module 401 may etch a region adjacent to an edge of the electrode sheet 22.

The edge of the electrode sheet 22 may extend in a longitudinal direction of the electrode sheet 22 or may be an elongated side. The longitudinal direction of the electrode sheet 22 may correspond to a direction in which the electrode sheet 22 is transported.

For example, a first sheet side 22a may be one side of the electrode sheet 22. For example, a second sheet side 22b may be another side of the electrode sheet 22. The first sheet side 22a and the second sheet side 22b may be positioned on sides opposite each other. The first sheet side 22a and the second sheet side 22b may extend or be elongated in the longitudinal direction of the electrode sheet 22.

The edge cutting module 401 may cut out a region adjacent to the sheet sides 22a and 22b of the electrode sheet 22 or a region including the sheet sides 22a and 22b. For example, when the edge cutting module 401 cuts the electrode sheet 22, a recessed shape may be formed in each of the sheet sides 22a and 22b. The sheet sides 22a and 22b may include or denote at least one of the first sheet side 22a and the second sheet side 22b.

The cutting unit 400 may include a transverse cutting module 402. The transverse cutting module 402 may cut the electrode sheet 22 transversely or in a widthwise direction thereof. The transverse or widthwise direction may be, for example, parallel to a Y-axis.

In other words, a cut line formed on the electrode sheet 22 by the transverse cutting module 402 may extend across the sheet sides 22a and 22b. For example, one end and the other end of the cut line formed on the electrode sheet 22 by the transverse cutting module 402 may respectively reach the first sheet side 22a and the second sheet side 22b.

The cutting unit 400 may include a cutter 420. For example, the cutter 420 may apply mechanical pressure to the electrode sheet 22 to cut the electrode sheet 22. For example, the cutter 420 may include a blade.

For another example, the cutter 420 may cut the electrode sheet 22 by irradiating the electrode sheet 22 with a laser beam. For example, the cutter 420 may include a laser device.

For example, the cutter 420 may apply heat to the electrode sheet 22 through the laser beam. For example, the cutter 420 may apply pressure to the electrode sheet 22 through the laser beam.

The electrode sheet 22 may have two surfaces. For example, the electrode sheet 22 may have an upper surface facing upward and a lower surface facing downward. The cutter 420 may apply pressure or irradiate a laser beam to the upper or lower surface of the electrode sheet 22. The upward and downward directions may be parallel to a Z-axis. For example, the cutter 420 may be positioned above the electrode sheet 22.

The cutter 420 may cut the electrode sheet 22 while the electrode sheet 22 is being transported. For example, the cutter 420 may cut the electrode sheet 22 while moving in a direction in which the electrode sheet 22 is transported.

For example, the cutter 420 may irradiate the electrode sheet 22 with a laser beam while moving in the direction in which the electrode sheet 22 is transported. For example, the cutter 420 may irradiate the electrode sheet 22 with a laser beam while moving in a direction parallel to or intersecting the direction in which the electrode sheet 22 is transported.

For example, the laser beam irradiated to the electrode sheet 22 by the cutter 420 may be applied to the electrode sheet 22 while moving in the direction parallel to or intersecting the direction in which the electrode sheet 22 is transported.

The cutting unit 400 may include a scanner 410. The scanner 410 may measure or capture an image of the electrode sheet 22. The scanner 410 may set a position of a cut line on the electrode sheet 22. The scanner 410 may be positioned above the electrode sheet 22.

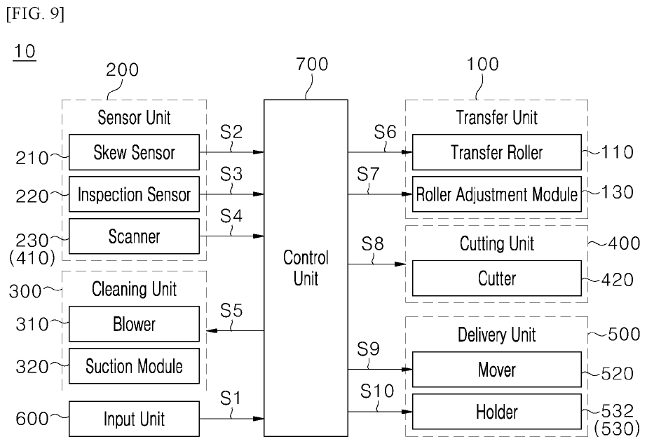

The cutter 420 may apply pressure or irradiate a laser beam to the cut line set by the scanner 410. For example, a control unit 700 (see FIG. 9) may set the cut line of the electrode sheet 22 based on the position of the electrode sheet 22 acquired by the scanner 410 and control the cutter 420 to apply pressure or irradiate a laser beam to the set cut line.

The scanner 410 may include a camera. As another example, the scanner 410 may include an X-ray device. A cut line may be set on the electrode sheet 22 based on the image of the electrode sheet 22 acquired by the scanner 410.

The cutting unit 400 may include a support jig 430. The support jig 430 may be positioned opposite the cutter 420 with the electrode sheet 22 interposed therebetween. For example, the electrode sheet 22 may be positioned between the cutter 420 and the support jig 430. For example, the cutter 420 may be positioned above the electrode sheet 22, and the support jig 430 may be positioned below the electrode sheet 22.

When the cutter 420 applies pressure to the electrode sheet 22, the support jig 430 may support pressure transmitted from the electrode sheet 22. Through this process, pressure may be effectively transmitted to the electrode sheet 22.

When the cutter 420 irradiates the electrode sheet 22 with a laser beam, the support jig 430 may dump or absorb the laser beam provided by the cutter 420. The support jig 430 may prevent the laser beam from damaging other components.

The cutting modules 401 and 402 may include or denote at least one of the edge cutting module 401 and the transverse cutting module 402. The cutting modules 401 and 402 may include the scanner 410. The cutting modules 401 and 402 may include the cutter 420. The cutting modules 401 and 402 may include the support jig 430.

The electrode manufacturing equipment 10 may include a sensor unit 200. The sensor unit 200 may include an inspection sensor 220. The inspection sensor 220 may inspect one surface of the electrode 25. The inspection sensor 220 may include a camera or an X-ray device.

The inspection sensor 220 may acquire an image of the electrode 25. The control unit 700 may analyze the image acquired by the inspection sensor 220 to determine whether the electrode 25 is normal.

FIG. 3 is a side view illustrating a delivery unit according to an embodiment of the present disclosure.

Referring to FIG. 3, the electrode manufacturing equipment 10 (see FIGS. 1 and 9) according to an embodiment of the present disclosure may include a delivery unit 500. The delivery unit 500 may be disposed adjacent to the transfer unit 100. The delivery unit 500 may be positioned in front of transfer unit 100.

Referring to FIGS. 1 to 3, the delivery unit 500 may transport the electrode 25. For example, the delivery unit 500 may receive the electrode 25 from the transfer unit 100 and transport the electrode 25 forward.

For another example, the electrode 25 may be separated from the electrode sheet 22 between the transfer unit 100 and the delivery unit 500. For example, the transverse cutting module 402 may cut the electrode sheet 22 between the transfer unit 100 and the delivery unit 500.

For example, the transverse cutting module 402 and the support jig 430 may be positioned between the transfer unit 100 and the delivery unit 500, with the electrode sheet 22 interposed therebetween.

The delivery unit 500 may include a track frame 510. The track frame 510 may have a shape extending in one direction. For example, the track frame 510 may have a shape extending in a front-rear direction. For example, the track frame 510 may extend or be elongated in the X-axis direction.

The track frame 510 may define a closed loop. The track frame 510 may include, for example, an upper track 510a and a lower track 510b.

The upper track 510a and the lower track 510b may have a shape extending in the front-rear direction. The upper track 510a may be positioned above the lower track 510b. The upper track 510a and the lower track 510b may be spaced apart from each other.

The track frame 510 may include a front track 510c. The front track 510c may extend from a front end of the upper track 510a to a front end of the lower track 510b. The front track 510c may be convex toward the front.

The track frame 510 may include a rear track 510d. The rear track 510d may extend from a rear end of the upper track 510a to a rear end of the lower track 510b. The rear track 510d may be convex toward the rear.

The upper track 510a, the front track 510c, the lower track 510b, and the rear track 510d may be sequentially connected to each other. The front track 510c, the lower track 510b, the rear track 510d, and the upper track 510a may be sequentially connected to each other.

The delivery unit 500 may include a mover 520. The mover 520 may be coupled to the track frame 510. For example, the mover 520 may be movably coupled to the track frame 510. A plurality of movers 520 may be provided.

The mover 520 may load the electrode 25. For example, the mover 520 may load the electrode 25 at the rear end of the upper track 510a. For example, when the mover 520 loads a front end of the electrode sheet 22 and the transverse cutting module 402 cuts the electrode sheet 22 transversely, the electrode 25 separated from the electrode sheet 22 may be loaded onto the mover 520.

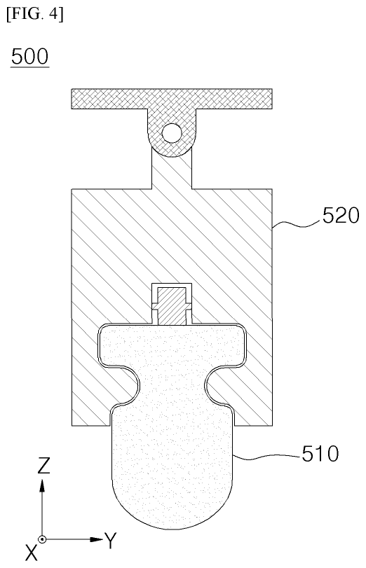

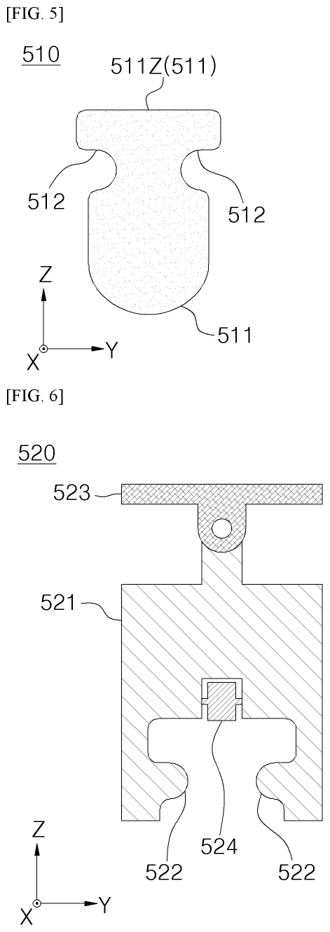

FIG. 4 is a cross-sectional view of the delivery unit shown in FIG. 3 taken along line X1-X2. FIG. 5 is a cross-sectional view illustrating the track frame of the delivery unit shown in FIG. 4. FIG. 6 is a cross-sectional view illustrating the mover of the delivery unit shown in FIG. 4.

Referring to FIGS. 3 to 6, the track frame 510 may include a track frame body 511. The track frame body 511 may extend or be elongated in one direction. The track frame body 511 may maintain rigidity.

The track frame body 511 may have one surface. For example, a track frame drive surface 511z may be one surface formed on the track frame body 511. The track frame drive surface 511z may be disposed to face the mover 520. For example, the track frame drive surface 511z may be coupled to the mover 520. For example, the mover 520 may move by applying force to the track frame drive surface 511z.

The track frame 510 may include a track frame guide 512. The track frame guide 512 may be formed on or coupled to the track frame body 511. For example, the track frame guide 512 may be concave or convex on a surface of the track frame body 511.

The mover 520 may include a mover body 521. The mover body 521 may maintain rigidity. The mover body 521 may move along the track frame 510. The mover body 521 may form a skeleton of the mover 520.

The mover 520 may include a mover guide 522. The mover guide 522 may be formed on or coupled to the mover body 521. The mover guide 522 may be coupled to the track frame guide 512.

For example, the track frame guide 512 may be a concave groove in the track frame body 511, and the mover guide 522 may be a protrusion protruding from the mover body 521.

For another example, the track frame guide 512 may be a protrusion protruding from the track frame body 511, and the mover guide 522 may be a concave groove in the mover body 521.

The mover 520 may include a mover drive unit 524. The mover drive unit 524 may be coupled to the track frame 510. For example, the mover drive unit 524 may include a motor that generates driving force. For example, the mover drive unit 524 may include a driver that provides power and signals to the motor.

For example, the mover drive unit 524 may include a wheel fixed to the motor and supplied with driving force. The wheel included in the mover drive unit 524 may have a gear-shaped form.

The wheel included in the mover drive unit 524 may contact or be coupled to the track frame drive surface 511z. For example, the track frame drive surface 511z may have an uneven structure. For example, when the wheel included in the mover drive unit 524 rotates, the mover 520 may move relative to the track frame 510.

For another example, the mover 520 may move on the track frame 510 by magnetic force. For another example, a component included in the track frame 510 may tow the mover 520 to move the mover 520.

The mover 520 may include a mover mount 523. For example, the mover mount 523 may form an upper surface of the mover 520. The mover mount 523 may be coupled to the mover body 521. For example, the mover mount 523 may be coupled to an upper portion of the mover body 521.

For example, when the mover 520 is positioned on the upper track 510a, the mover mount 523 may define the upper surface of the mover 520. For example, when the mover 520 is positioned on the lower track 510b, the mover mount 523 may define a lower surface of the mover 520.

The mover mount 523 may be movably coupled to the mover body 521. For example, the mover mount 523 may be rotatably coupled to the mover body 521.

The mover mount 523 may load the electrode 25 (see FIGS. 1 and 2). When the mover mount 523 moves or rotates relative to the mover body 521, the mover mount 523 may unload the electrode 25 (see FIGS. 1 and 2).

While the mover 520 is loaded with the electrode 25 (see FIGS. 1 and 2), the mover 520 may move forward on the upper track 510a. While the mover 520 is positioned on the upper track 510a, the inspection sensor 220 (see FIG. 1) may inspect the electrode 25 (see FIGS. 1 and 2).

For example, when the inspection sensor 220 (see FIG. 1) acquires an image of the electrode 25 (see FIGS. 1 and 2), the control unit 700 (see FIG. 9) may analyze the image of the electrode 25 (see FIGS. 1 and 2) to determine whether the electrode 25 (see FIGS. 1 and 2) is normal. The image of electrode 25 (see FIGS. 1 and 2) may be, for example, a vision image or an X-ray projection image.

The control unit 700 (see FIG. 9) may utilize a model based on machine learning or deep learning in the process of determining whether electrode 25 (see FIGS. 1 and 2) is normal.

For example, the control unit 700 (see FIG. 9) may train on various images and conditions of the electrode 25 (see FIGS. 1 and 2). Through training, the control unit 700 (see FIG. 9) may generate a model for determining whether the electrode 25 (see FIGS. 1 and 2) is normal. The control unit 700 (see FIG. 9) may determine in real time whether the electrode 25 (see FIGS. 1 and 2) is normal.

A magazine (not shown) for loading the electrode 25 (see FIGS. 1 and 2) may be disposed adjacent to the delivery unit 500. For example, the magazine (not shown) and the track frame 510 may be arranged in a transverse or widthwise direction. The transverse or widthwise direction may be parallel to the Y-axis.

A plurality of magazines (not shown) may be provided. For example, a first magazine (not shown) may accommodate a normal electrode 25 (see FIGS. 1 and 2). For example, a second magazine (not shown) may accommodate an abnormal electrode 25 (see FIGS. 1 and 2).

If the electrode 25 (see FIGS. 1 and 2) is determined to be normal, the mover 520 may move forward from the rear end of the upper track 510a to be positioned beside the first magazine (not shown). The mover mount 523 may move or rotate relative to the mover body 521 to load the electrode 25 (see FIGS. 1 and 2) into the first magazine (not shown).

If the electrode 25 (see FIGS. 1 and 2) is determined to be abnormal, the mover 520 may move beside the second magazine (not shown). The mover mount 523 may move or rotate relative to the mover body 521 to load the electrode 25 (see FIGS. 1 and 2) into the second magazine (not shown).

After the electrode 25 (see FIGS. 1 and 2) is removed from the mover 520, the mover 520 may return to the rear end of the upper track 510a via the front track 510c, the lower track 510b, and the rear track 510d.

For another example, if the electrode 25 (see FIGS. 1 and 2) is determined to be abnormal, the mover 520 may move to the front track 510c. When the mover 520 is positioned on the front track 510c, the electrode 25 (see FIGS. 1 and 2) loaded on the mover 520 may be dropped. Thereafter, the mover 520 may return to the rear end of the upper track 510a via the lower track 510b and the rear track 510d.

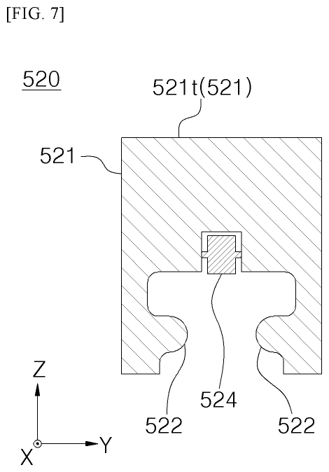

FIG. 7 is a cross-sectional view illustrating the mover, where an upper surface of the mover body forms an upper surface of the mover.

Referring to FIG. 3 and FIG. 7, the mover body 521 may define an upper surface 521t of the mover body. For example, when the mover 520 is positioned on the upper track 510a, the upper surface 521t of the mover body may define the upper surface of the mover 520. For example, when the mover 520 is positioned on the lower track 510b, the upper surface 521t of the mover body may define the lower surface of the mover 520.

While the mover 520 is positioned on the upper track 510a, the electrode 25 (see FIGS. 1 and 2) loaded on the mover 520 may need to be transferred to and loaded into a separate magazine (not shown). If the mover 520 does not include the mover mount 523 (see FIG. 6), a separate device may be required to transfer the electrode 25 (see FIGS. 1 and 2) loaded on the mover 520 to a magazine (not shown).

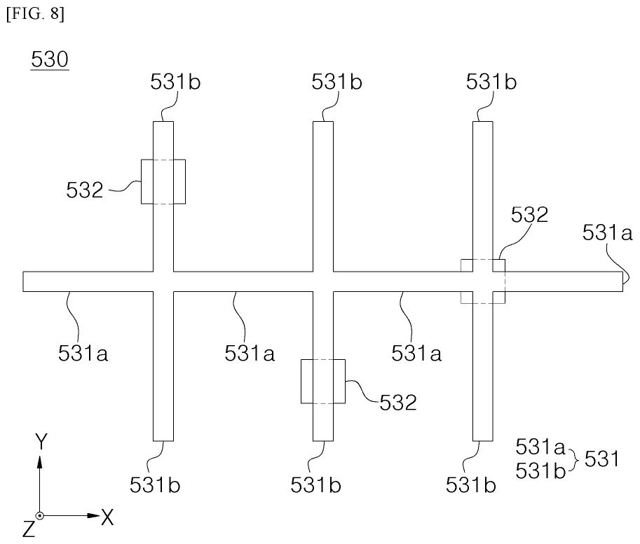

FIG. 8 is a view illustrating a pick-and-place (PNP) module according to an embodiment of the present disclosure.

A PNP module 530 may include a PNP frame 531. The PNP frame 531 may be positioned above the track frame 510 (see FIG. 3). The PNP frame 531 may include a PNP longitudinal beam 531a and a PNP transverse beam 531b.

The PNP longitudinal beam 531a may extend or be elongated in the longitudinal direction. For example, the PNP longitudinal beam 531a may extend or be elongated in the front-rear direction. The PNP longitudinal beam 531a may be positioned above the track frame 510 (see FIG. 3).

For example, the PNP longitudinal beam 531a may be positioned above the upper track 510a (see FIG. 3). For example, when the mover 520 (see FIG. 3) is positioned on the upper track 510a (see FIG. 3), the PNP longitudinal beam 531a may be positioned above the mover 520 (see FIG. 3).

The PNP transverse beam 531b and the PNP longitudinal beam 531a may intersect. The PNP transverse beam 531b and the PNP longitudinal beam 531a may extend horizontally. The PNP transverse beam 531b may extend in a widthwise direction or a transverse direction of the track frame 510 (see FIG. 3) at at least one point of the PNP longitudinal beam 531a. A plurality of PNP transverse beam 531b may be provided. The plurality of PNP transverse beams 531b may be arranged spaced apart from each other in the longitudinal direction of the track frame 510 (see FIG. 3).

The PNP module 530 may include a holder 532. The holder 532 may be coupled to the PNP transverse beam 531b. For example, the holder 532 may be movably coupled along the PNP transverse beam 531b. A longitudinal direction of the PNP transverse beam 531b may correspond to a transverse direction or a widthwise direction of the delivery unit 500 (see FIG. 3). That is, when the holder 532 moves along the PNP transverse beam 531b, a position of the holder 532 relative to the widthwise direction of the delivery unit 500 (see FIG. 3) may change.

When the mover 520 (see FIG. 3) is positioned on the upper track 510a (see FIG. 3), the holder 532 may be positioned above the mover 520 (see FIG. 3). The holder 532 may move downward from the PNP frame 531.

The holder 532 may hold the electrode 25 (see FIGS. 1 and 2) loaded onto the mover 520 (see FIG. 3). For example, the electrode 25 (see FIGS. 1 and 2) loaded onto the mover 520 (see FIG. 3) may be held by the holder 532 and may be releasably coupled thereto.

The holder 532 may move upward. The holder 532 may move in the widthwise direction of the delivery unit 500 (see FIG. 3). A magazine (not shown) may be positioned below the holder 532. The holder 532 may move downward toward the magazine. The holder 532 may be separated from the electrode 25 (see FIGS. 1 and 2). The electrode 25 (see FIGS. 1 and 2) may then be loaded into the magazine.

FIG. 9 is a block diagram illustrating electrode manufacturing equipment according to an embodiment of the present disclosure.

Referring to FIGS. 1 to 9, the electrode manufacturing equipment 10 according to an embodiment of the present disclosure may include an input unit 600. The input unit 600 may receive commands related to the operation of the electrode manufacturing equipment 10 from a user.

The input unit 600 may generate a signal. For example, the input unit 600 may generate a first signal S1 and transmit it to the control unit 700. The first signal S1 may include information related to the operation of the electrode manufacturing equipment 10.

According to an embodiment of the present disclosure, the electrode manufacturing equipment 10 may include the control unit 700. The control unit 700 may generate or process signals. The control unit 700 may perform computations.

The control unit 700 may include at least one of a processor, a central processing unit (CPU), a graphical processing unit (GPU), a computer, a laptop, a server, a printed circuit board (PCB), a circuit board (CB), or a flexible printed circuit board (FPCB).

According to an embodiment of the present disclosure, the electrode manufacturing equipment 10 may include the sensor unit 200. The sensor unit 200 may include a skew sensor 210. The skew sensor 210 may measure the position and/or shape of the electrode sheet 22.

For example, the skew sensor 210 may measure the position and/or shape of the electrode sheet 22 relative to a reference point. For example, the skew sensor 210 may include an encoder that measures the position and/or shape of the electrode sheet 22 relative to the reference point.

The skew sensor 210 may generate a signal. For example, the skew sensor 210 may generate a second signal S2 and transmit it to the control unit 700. The second signal S2 may include information related to the position and/or shape of the electrode sheet 22.

The sensor unit 200 may include the inspection sensor 220. The inspection sensor 220 may be disposed adjacent to the transfer unit 100. The inspection sensor 220 may be disposed adjacent to the delivery unit 500.

The inspection sensor 220 may generate data or images to determine whether the cutting applied to the electrode sheet 22 is valid. For example, the inspection sensor 220 may include a camera (a visible-light camera or an infrared camera) that captures an image of the electrode sheet 22 or the electrode 25. For example, the inspection sensor 220 may include an X-ray device that captures an X-ray image of the electrode sheet 22 or the electrode 25.

The inspection sensor 220 may be disposed to face one surface of the electrode 25 loaded on the mover 520. In this case, the inspection sensor 220 may capture an image of one surface of the electrode 25 and a lateral face (thickness surface) of the electrode 25. The one surface of the electrode 25 loaded on the mover 520 may correspond to an upper surface of the electrode 25. The upper surface of the electrode 25 may face or be directed upward. The inspection sensor 220 positioned above the mover 520 may be referred to as an “upper inspection sensor.”

The inspection sensor 220 may be disposed to face the other surface of the electrode 25 coupled to the holder 532. In this case, the inspection sensor 220 may capture an image of the other surface of the electrode 25 and a lateral face of the electrode 25. The other surface of the electrode 25 loaded on the holder 532 may correspond to a lower surface of the electrode 25. The lower surface of the electrode 25 may face or be directed downward. The inspection sensor 220 positioned below the holder 532 may be referred to as a “lower inspection sensor.”

The inspection sensor 220 may generate a signal. For example, the inspection sensor 220 may generate a third signal S3 and transmit it to the control unit 700. The third signal S3 may include an image captured of the electrode sheet 22 or the electrode 25. For example, the third signal S3 may include an image captured of a cross-section of the electrode sheet 22 or the electrode 25 cut by the cutter 420.

The sensor unit 200 may include a scanner 230. The scanner 230 included in the sensor unit 200 may be the scanner 410 included in the cutting unit 400. In other words, the scanners (230, 410) may belong to the sensor unit 200 and the cutting unit 400.

The scanner 230 may measure or capture an image of the electrode sheet 22. The scanner 230 may generate a fourth signal S4 and transmit it to the control unit 700. The fourth signal S4 may include an image captured of the electrode sheet 22 captured by the scanner 230.

The control unit 700 may set the position of a cut line on the electrode sheet 22 based on the fourth signal S4. The control unit 700 may generate an eighth signal S8 based on the fourth signal S4. The eighth signal S8 may include information related to the position of the cut line set on the electrode sheet 22.

The cutter 420 may operate based on the eighth signal S8. For example, the cutter 420, operating based on the eighth signal S8, may cut the electrode sheet 22 along the cut line.

The control unit 700 may generate output signals S5, S6, S7, S8, S9, and S10 based on the input signals S1, S2, S3, and S4. The input signals S1, S2, S3, and S4 may include or denote at least one of the first signal S1, the second signal S2, the third signal S3, and the fourth signal S4. The output signals S5, S6, S7, S8, S9 and S10 may include or denote at least one of a fifth signal S5, a sixth signal S6, a seventh signal S7, the eighth signal S8, a ninth signal S9 and a tenth signal S10.

The control unit 700 may generate the sixth signal S6 based on the input signals S1, S2, S3, and S4. The sixth signal S6 may be transmitted to the transfer roller 110. The transfer roller 110 may operate in response to the sixth signal S6. For example, the transfer roller 110 may rotate in response to the sixth signal S6. The rotation speed and/or rotation direction of the transfer roller 110 may vary in response to the sixth signal.

The transfer unit 100 may include a roller adjustment module 130. The roller adjustment module 130 may adjust the position of the transfer roller 110, and the like.

The control unit 700 may generate the seventh signal S7 based on the input signals S1, S2, S3, and S4. For example, the control unit 700 may generate the seventh signal S7 based on the second signal S2. The control unit 700 may transmit the seventh signal S7 to the roller adjustment module 130. The roller adjustment module 130 may adjust the position of the transfer roller 110, and the like, in response to the seventh signal S7.

The control unit 700 may generate the ninth signal S9 based on the input signals S1, S2, S3, and S4. The control unit 700 may transmit the ninth signal S9 to the mover 520. The mover 520 may move in response to the ninth signal S9.

For example, a leading mover 520, located at the rear end of the upper track 510a, may move forward if it is determined that the leading mover 520 is loaded with electrode 25. In addition, a trailing mover 520, located behind the leading mover 520, may move to the rear end of the upper track 510a. If the leading mover 520 and the trailing mover 520 are located on the upper track 510a, the leading mover 520 may be positioned in front of the trailing mover 520.

If the electrode 25 loaded on the mover 520 is determined to be normal, the mover 520 may move to be adjacent to a magazine (not shown) where the electrode 25 loaded on the mover 520 will be placed. Then, the mover mount 523 may operate to load the electrode 25 into the magazine (not shown).

If the electrode 25 loaded on the mover 520 is determined to be abnormal, the mover 520 may move to a separate magazine (not shown) that is configured to accommodate the abnormal electrode 25 and load the abnormal electrode 25 into the separate magazine, or move to the lower track 510b after dropping the abnormal electrode 25 from the front track 510c.

If the mover 520 does not include the mover mount 523 and the electrode 25 is loaded on the upper surface 521t of the mover body, the holder 532 may operate. The control unit 700 may generate the tenth signal S10 based on the input signals S1, S2, S3, and S4 and transmit the tenth signal S10 to the holder 532.

The holder 532 may operate in response to the tenth signal S10. The holder 532 may move upward along the PNP frame 531. The holder 532 may move toward the electrode 25 loaded on the mover 520.

The holder 532 may releasably coupled to the electrode 25 loaded on the mover 520. For example, the holder 532 may employ a vacuum adhesion method. For example, the holder 532 may draw in air to generate negative pressure between the holder 532 and the electrode 25.

The holder 532 may move along the PNP transverse beam 531b. For example, the holder 532 may travel along the PNP transverse beam 531b in the longitudinal direction of the PNP transverse beam 531b. If the electrode 25 held by the holder 532 is determined to be normal, the holder 532 may move to a position above the first magazine (not shown). If the electrode 25 held by the holder 532 is determined to be abnormal, the holder 532 may move to a position above the second magazine (not shown).

The holder 532 may separate the electrode 25 loaded on the mover 520 from the mover 520. For example, the holder 532 may stop forming the negative pressure. For example, the holder 532 may spray air or gas toward the electrode 25.

The electrode 25 separated from the holder 532 may be loaded into the first magazine (not shown) or the second magazine (not shown). If the electrode 25 loaded onto the mover 520 is determined to be abnormal, the holder 532 may not operate, and the electrode 25 may remain loaded on the mover 520. In this case, the electrode 25 loaded onto the mover 520 may be dropped from the front track 510c.

The electrode manufacturing equipment 10 according to an embodiment of the present disclosure may include a cleaning unit 300. During the process in which the cutter 420 cuts the electrode sheet 22, metal powder or harmful gases may be generated. The cleaning unit 300 may remove the metal powder or harmful gases by suction.

The cleaning unit 300 may include a blower 310. The blower 310 may be disposed adjacent to the cutter 420. The blower 310 may direct gas or air toward the electrode sheet 22. For example, the blower 310 may direct gas or air toward the cut line on the electrode sheet 22.

The cleaning unit 300 may also include a suction module 320. The suction module 320 may suction gas or air. For example, the blower 310 may direct gas or air to the electrode sheet 22, and the suction module 320 may suction air containing metal powder or harmful gases.

The control unit 700 may generate the fifth signal S5 based on the input signals S1, S2, S3, and S4 and transmit it to the cleaning unit 300. The cleaning unit 300 may operate in response to the fifth signal S5. The fifth signal S5 may include information related to the operation of the cleaning unit 300.

The transfer unit 100 may unroll the electrode roll 21 to form the electrode sheet 22, and the cutting unit 400 may cut the electrode sheet 22 to form the electrode 25. The delivery unit 500 may load the electrode 25 into the magazine while moving the electrode 25.

The electrode manufacturing equipment 10 may produce the electrode 25 from the electrode roll 21 and load it into the magazine. The process of producing the electrode 25 by the electrode manufacturing equipment 10 from the electrode roll 21 and loading it into the magazine may be performed without interruption.

The contents described above are merely examples of applying the principles of the present disclosure, and other configurations may be further included without departing from the scope of the present disclosure.

1. An electrode manufacturing equipment comprising:
a transfer unit having a transfer roller configured to transport an electrode sheet forward;
a cutting unit having a cutter configured to cut the electrode sheet; and
a delivery unit positioned in front of the transfer unit,
wherein the delivery unit comprises:
a track frame positioned in front of the transfer unit and having an upper track extending forward from a rear end thereof; and
a mover movably coupled to the track frame.

2. The electrode manufacturing equipment according to claim 1, wherein the cutting unit comprises a transverse cutting module configured to cut the electrode sheet in a widthwise direction of the electrode sheet.

3. The electrode manufacturing equipment according to claim 2, wherein when the transverse cutting module cuts the electrode sheet, a front end of the electrode sheet is separated from the electrode sheet to form an electrode.

4. The electrode manufacturing equipment according to claim 3, wherein the electrode is loaded onto the mover.

5. The electrode manufacturing equipment according to claim 2, wherein the electrode sheet is elongated in a longitudinal direction thereof and includes a first sheet side and a second sheet side positioned on sides opposite each other, and
the transverse cutting module cuts the electrode sheet across the first sheet side and the second sheet side.

6. The electrode manufacturing equipment according to claim 5, wherein the transverse cutting module is positioned between the transfer unit and the delivery unit.

7. The electrode manufacturing equipment according to claim 5, wherein the transverse cutting module comprises:
a cutter disposed to face one surface of the electrode sheet; and
a support jig disposed to face the other surface of the electrode sheet.

8. The electrode manufacturing equipment according to claim 7, wherein the cutter irradiates the one surface of the electrode sheet with a laser beam, and
the support jig dumps a portion of the laser beam that has penetrated the electrode sheet.

9. The electrode manufacturing equipment according to claim 7, wherein the cutter mechanically applies pressure to the one surface of the electrode sheet, and
the support jig supports the pressure transferred to the other surface of the electrode sheet during application of pressure.

10. The electrode manufacturing equipment according to claim 1, wherein the cutting unit comprises a cutter configured to irradiate the electrode sheet with a laser beam, and
the laser beam is applied to the electrode sheet while moving in a direction parallel to or intersecting a direction in which the electrode sheet is transported.

11. The electrode manufacturing equipment according to claim 1, wherein the track frame defines a closed loop.

12. The electrode manufacturing equipment according to claim 11, wherein the track frame comprises:
a lower track positioned below the upper track;
a front track extending from a front end of the upper track to a front end of the lower track; and
a rear track extending from a rear end of the upper track to a rear end of the lower track.

13. The electrode manufacturing equipment according to claim 1, wherein the upper track comprises:
a track frame body extending forward from the rear end;
a track frame guide formed on the track frame body,
wherein the mover is coupled to the track frame guide and configured to move along the upper track.

14. The electrode manufacturing equipment according to claim 13, wherein the mover comprises:
a mover body; and
a mover guide formed on the mover body and coupled to the track frame guide.

15. The electrode manufacturing equipment according to claim 14, wherein the mover further comprises a mover drive unit coupled to the mover body and configured to provide a driving force with respect to the track frame body.

16. The electrode manufacturing equipment according to claim 14, wherein the mover further comprises a mover mount movably or rotatably coupled to the mover body and configured to define an upper surface of the mover.

17. The electrode manufacturing equipment according to claim 13, wherein the delivery unit further comprises a PNP module,
wherein the PNP module comprises:
a PNP longitudinal beam positioned above the upper track and extending forward from a rear end to a front end;
a PNP transverse beam extending horizontally and intersecting the PNP longitudinal beam; and
a holder movably coupled to the PNP transverse beam.

18. The electrode manufacturing equipment according to claim 17, wherein the holder is movably coupled to the PNP transverse beam so as to be movable along the longitudinal direction of the PNP transverse beam, and is coupled to the PNP transverse beam to be vertically movable on the PNP transverse beam.

19. The electrode manufacturing equipment according to claim 1, wherein the cutting unit cuts the electrode sheet to form an electrode, and
the mover loads the electrode thereon.

20. The electrode manufacturing equipment according to claim 1, further comprising an upper inspection sensor configured to capture an image of an upper surface of the electrode; and
a lower inspection sensor configured to capture an image of a lower surface of the electrode.
